(19) United States
(12) Patent Application Publication
(10) Pub. No.: US 2026/0042006 A1
(43) Pub. Date: Feb. 12, 2026

(54) STORAGE MEDIUM, INFORMATION PROCESSING SYSTEM, AND GAME PROCESSING METHOD

(71) Applicant: NINTENDO CO., LTD., Kyoto (JP)

(72) Inventor: Tomohiro NAKATANI, Kyoto (JP)

(21) Appl. No.: 19/278,360

(22) Filed: Jul. 23, 2025

(30) Foreign Application Priority Data
Aug. 7, 2024 (JP) 2024-130661

(51) Int. Cl. A63F 13/525; A63F 13/803

(52) U.S. Cl. CPC A63F 13/525; A63F 13/803

(57) ABSTRACT

A racing game in which a player object and a plurality of other moving objects are caused to move on a field in a virtual space, is performed. In the racing game, an example of an information processing system sets a virtual camera in the virtual space at a position behind the player object, in a direction in which at least the player object is included in a field of view of the virtual camera, so that the virtual camera follows movement of the player object. Based on the virtual camera, the information processing system performs rendering of the objects in the virtual space, and during the rendering, enlarges and renders at least the other moving object among the objects in the virtual space by using a vertex shader, at a magnification that increases as at least a distance from the virtual camera becomes farther within a first range.

### CROSS REFERENCE TO RELATED APPLICATION

This application claims priority to Japanese Patent Application No. 2024-130661, filed on Aug. 7, 2024, the entire contents of which are incorporated herein by reference.

### FIELD

The technique shown here relates to a storage medium, an information processing system, and a game processing method for generating a game image showing a virtual space in which objects are placed.

### BACKGROUND AND SUMMARY

Conventionally, in a game such as a racing game, a game image in a field-of-view range including a player object to be operated by a player is generated, and the state of a game field in a predetermined direction (e.g., forward) from the player object is displayed.

In a game, it is desired to improve visibility of an object placed in a virtual space.

Therefore, the present application discloses a storage medium, an information processing system, and a game processing method capable of improving visibility of an object placed in a virtual space.

(1)

An example of one or more non-transitory computer-readable medium having stored therein instructions that, when executed, cause one or more processors of an information processing apparatus to execute information processing comprising: performing a racing game by causing a player object controlled based on an operation input and a plurality of other moving objects to move on a field in a virtual space; and in the racing game, setting a virtual camera in the virtual space at a position behind the player object, in a direction in which at least the player object is included in a field of view of the virtual camera, so that the virtual camera follows movement of the player object, and based on the virtual camera, performing rendering of the objects in the virtual space, and during the rendering, enlarging and rendering at least the other moving object among the objects in the virtual space by using a vertex shader, at a magnification that increases as at least a distance from the virtual camera becomes farther within a first range.

According to the configuration of the above (1), in the racing game, visibility of the other moving object preceding the player object can be improved.

(2)

In the configuration of the above (1), the magnification may be set to be a first magnification when the distance from the virtual camera is a first distance, to be a second magnification higher than the first magnification when the distance from the virtual camera is a second distance farther than the first distance, and to be a magnification obtained by linearly interpolating the first magnification and the second magnification according to the distances between the first distance and the second distance.

According to the configuration of the above (2), the magnification at which the object is enlarged can be calculated through a simple calculation according to the distance.

(3)

In the configuration of the above (2), the magnification may be set to be a third magnification higher than the second magnification when the distance from the virtual camera is a third distance farther than the second distance, and to be a magnification obtained by linearly interpolating the second magnification and the third magnification according to the distances between the second distance and the third distance.

According to the configuration of the above (3), the relationship between magnification and distance can be set in more detail.

(4)

In the configuration of the any one of above (1) to (3), the information processing may further comprise, during the rendering, enlarging and rendering an object of a type other than the player object and the other moving objects among the objects in the virtual space by using the vertex shader, at a magnification that increases as at least the distance from the virtual camera becomes farther within a second range and that is different from the magnifications of the other moving objects.

According to the configuration of the above (4), the magnification can be varied according to the type of object. For example, an object of a type for which improved visibility is desired and an object of the other type may have different magnifications.

(5)

In the configuration of the any one of above (1) to (4), the information processing may comprise, during the rendering, enlarging at least the other moving object at the magnification by using the vertex shader, and rendering the other moving object at a position where a height of a lower surface of the other moving object is not changed from that before the enlargement.

According to the configuration of the above (5), it is possible to reduce the possibility that the moving object is unnaturally displayed due to enlargement.

(6)

In the configuration of the above (5), the other moving object may be an object including a vehicle object and a character object riding in or on the vehicle object at a reference position on the vehicle object. The information processing may comprise, during the rendering, enlarging at least the other moving object at the magnification by using the vertex shader, and rendering the other moving object such that the vehicle object is rendered at a position where a height of a lower surface of the vehicle object is not changed from that before the enlargement and the character object is rendered at a position where a height of a lower surface of the character object is on the reference position of the vehicle object after the enlargement.

According to the configuration of the above (6), it is possible to reduce the possibility that the vehicle object and the character object are unnaturally displayed due to enlargement.

(7)

In the configuration of the any one of above (1) to (6), the distance from the virtual camera may be a distance in the virtual space or a distance regarding a depth component of the virtual camera.

According to the configuration of the above (7), the magnification can be changed according to the three-dimensional distance from the virtual camera or the distance in the depth direction.

Note that the present specification discloses an example of an information processing apparatus (e.g., game apparatus) or an information processing system (e.g., game system) that executes the processes in the above (1) to (7). Furthermore, the present specification discloses an example of a game processing method for executing the processes in the above (1) to (7).

According to the storage medium, the information processing system, the information processing apparatus, or the game processing method described above, visibility of an object placed in the virtual space can be improved.

These and other objects, features, aspects and advantages of the exemplary embodiment will become more apparent from the following detailed description when taken in conjunction with the accompanying drawings.

### BRIEF DESCRIPTION OF THE DRAWINGS

FIG. 1 shows an example of non-limiting game system;

FIG. 2 a block diagram showing an example of the internal configuration of a non-limiting main body apparatus;

FIG. 3 shows an example of a game image;

FIG. 4 shows examples of a game image in which objects are enlarged and a game image in which the objects are not enlarged;

FIG. 5 is a graph showing an example of the relationship between magnification and distance when a moving object is enlarged;

FIG. 6 is a graph showing an example of the relationship between magnification and distance when an object other than the moving object is enlarged;

FIG. 7 shows examples in which two objects placed on a field are enlarged at different magnifications;

FIG. 8 shows an example of a method for enlarging an object;

FIG. 9 shows an example of enlargement of a moving object;

FIG. 10 shows an example of a storage area having, stored therein, various data to be used for information processing in the non-limiting game system;

FIG. 11 is a flowchart showing an example of a flow of game processing executed by the non-limiting game system;

FIG. 12 is a sub-flowchart showing an example of a specific flow of a magnification setting process in step S5 shown in FIG. 11; and

FIG. 13 is a sub-flowchart showing an example of a specific flow of a rendering process in step S6 shown in FIG. 11.

### DETAILED DESCRIPTION OF NON-LIMITING EXAMPLE EMBODIMENTS

### (1. Game System Configuration)

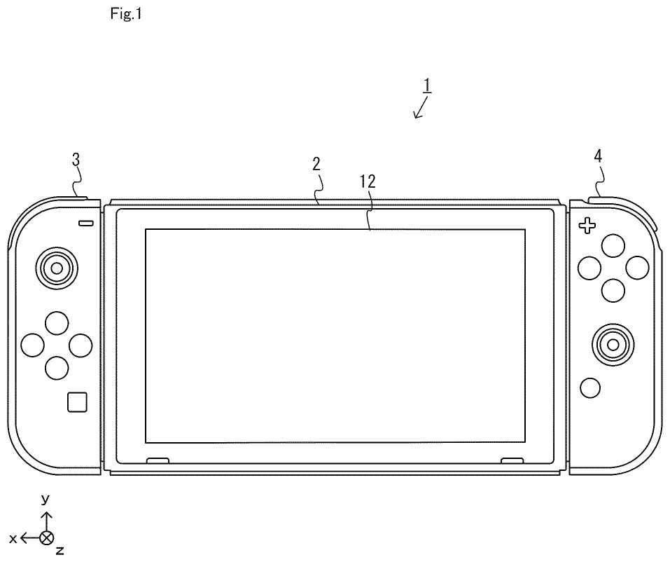

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of buttons and an analog stick, as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

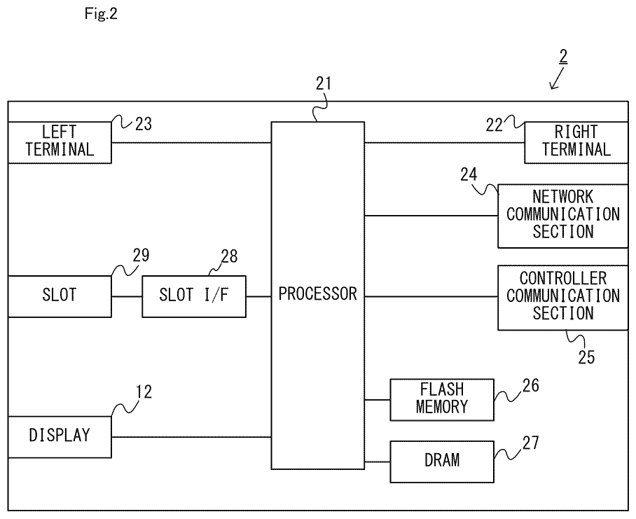

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes a CPU (Central Processing Unit) and a GPU (Graphics Processing Unit). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 23, which is a terminal for the main body apparatus 2 to perform wired communication with the left controller 3, and a right terminal 22, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4 detached from the main body apparatus 2. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 23 and the right terminal 22. When performing wired communication with the left controller 3, the processor 21 transmits data to the left controller 3 via the left terminal 23 and also receives operation data from the left controller 3 via the left terminal 23. Further, when performing wired communication with the right controller 4, the processor 21 transmits data to the right controller 4 via the right terminal 22 and also receives operation data from the right controller 4 via the right terminal 22. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### [2. Game Example in Game System]

Next, an example of a game executed in the game system 1 will be described. The game of the exemplary embodiment is a game in which moving objects are caused to move on a field in a virtual space (or game space). In the exemplary embodiment, the player plays the game by operating a moving object as a player object.

A moving object is an object that moves on the field. For example, an object that moves on the field, such as a car, a motorcycle, a bicycle, a horse, a runner, or the like may be used as a moving object. A character imitating a person, an animal, or the like may be used as a moving object, and a game in which such a character moves may be performed.

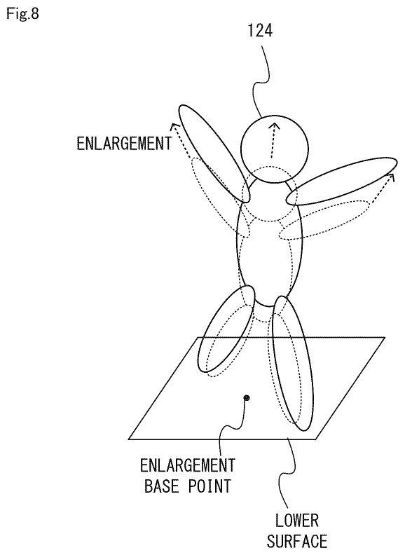

In the exemplary embodiment, a moving object includes a vehicle object and a character object that rides in or on the vehicle object (see FIG. 8). Hereinafter, a description will be given of a case where the game is performed using a moving object in which a character rides in or on a vehicle object such as a car that moves on the ground. However, in other embodiments, a moving object may be simply a vehicle object or a character object. In the exemplary embodiment, the moving object moves on the field, but may not necessarily be always in contact with the ground. The moving object may be able to take off and fly in the sky or move on or in the water.

In the exemplary embodiment, there are a plurality of types of moving objects having different shapes, sizes, powers, etc. The player selects a type of moving object to be used as a player object before playing the game.

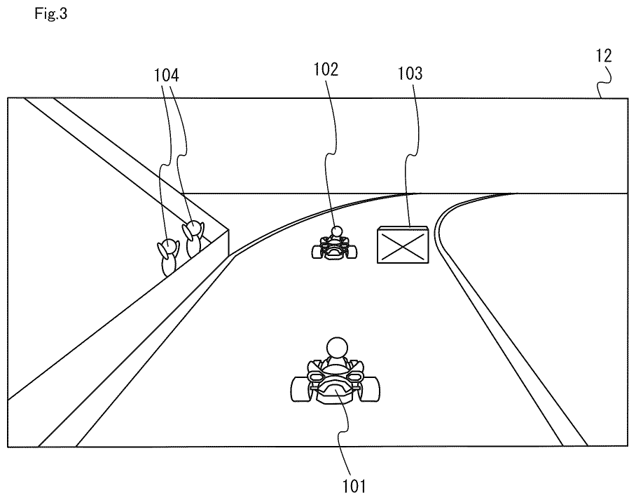

FIG. 3 shows an example of a game image in the exemplary embodiment. As shown in FIG. 3, in the exemplary embodiment, a racing game in which a player object 101 races with another moving object 102 is executed. In the exemplary embodiment, in addition to the moving objects that move on a racing course, other types of objects, such as an obstacle object 103 that obstructs movement of the moving objects and audience objects 104 placed around the racing course, are placed on the field. The types of objects placed on the field in the game are discretionary, and other types of objects different from the above objects 101 to 104 may be placed. In the exemplary embodiment, item objects and box objects described later are placed on the field in addition to the objects 101 to 104.

As shown in FIG. 3, the game system 1 performs movement control for a virtual camera in the virtual space to generate a game image including the player object 101. In the exemplary embodiment, the virtual camera is set at a position behind the player object 101, in a direction in which at least the player object 101 is included in the field of view of the virtual camera, so that the virtual camera follows movement of the player object 101. Thus, a game image showing a field in which the player object 101 is viewed from the back side is generated and displayed (see FIG. 3). For example, the position of the virtual camera is controlled to be a predetermined reference position, based on the position and the direction of the player object 101. The reference position may be, for example, a position at a predetermined distance behind the position of the player object 101, and regarding the height direction, at a predetermined height above the position of the player object 101. The direction of the virtual camera set at the reference position is set to face the player object 101.

The virtual camera may not necessarily be always positioned at the reference position. For example, the virtual camera may be controlled so as to rotate and move while maintaining the line-of-sight direction thereof being directed to the player object 101, in response to a predetermined operation input performed by the player (e.g., an input indicating a direction). In order to allow the player to check the back side of the player object 101, the position and the direction of the virtual camera may be controlled such that the player object 101 is viewed from the front, in response to a predetermined operation input performed by the player. After the operation input to move the virtual camera from the reference position has ended, the virtual camera is subjected to movement control so as to include the player object in the field of view thereof and follow movement of the player object, whereby the virtual camera is gradually moved to the reference position. In the exemplary embodiment, enlargement display of an object described later is performed regardless of the position and the direction of the virtual camera.

In other embodiments, the virtual camera may be controlled to provide a so-called first-person viewpoint, and a game image including no player character may be generated.

Here, an object at a position far from the virtual camera (e.g., another moving object that is moving ahead of the player object) is displayed to be smaller than in the case where this object is near the virtual camera. Therefore, in the exemplary embodiment, in order to improve visibility of the object at the position far from the virtual camera, the game system 1 displays this object in an enlarged manner.

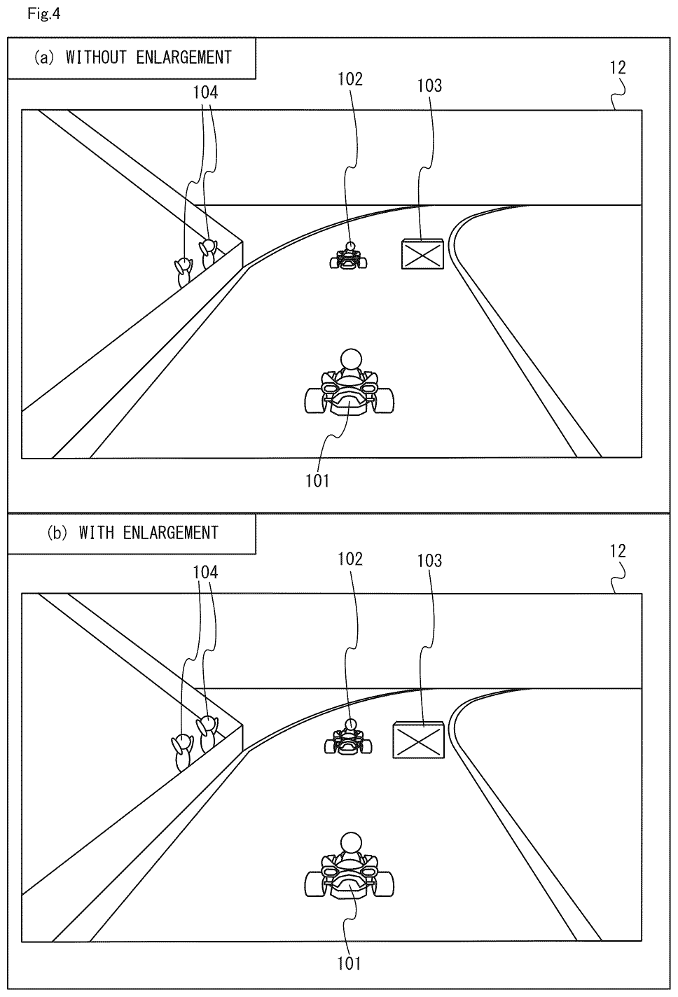

FIG. 4 shows examples of a game image in which objects are enlarged and a game image in which the objects are not enlarged. In FIG. 4, (a) shows the example of the game image in which the objects are not enlarged and (b) shows the example of the game image in which the objects are enlarged. In the example shown in FIG. 4, the moving object 102, the obstacle object 103, and the audience objects 104 are enlarged because the distances of these objects from the virtual camera are equal to or more than a predetermined distance.

As shown in FIG. 4, the objects 102 to 104 whose distances from the virtual camera are equal to or more than the predetermined distance are enlarged and displayed, compared to the case where the sizes thereof in the three-dimensional virtual space are reflected as they are. This improves visibilities of the objects at the positions far from the virtual camera. For example, since the player can easily visually recognize an object positioned ahead of the player object 101, the player can easily identify the other moving object 102 moving ahead of the player object 101 in the race, and can readily notice the obstacle object 103 located ahead of the player object 101 in the racing course. For example, in the racing game, it is conceivable that a scene in which a plurality of other moving objects are moving ahead of the player object 101 is generated. In such a scene, if these moving objects are enlarged and displayed, the player can easily grasp the situation ahead of the player object 101.

In the racing game of the exemplary embodiment, the angle of view (or viewing angle) of the virtual camera is set to be wide to increase the sense of speed that the player perceives when the viewpoint of the virtual camera moves according to movement of the player object 101, thereby improving the sense of realism in the game. For example, in the exemplary embodiment, the vertical angle of view of the virtual camera is set at 65°. If the angle of view of the virtual camera is set wide as described above, the object is likely to be displayed small, which may reduce the visibility. However, according to the exemplary embodiment, even if the angle of view of the virtual camera is set wide, reduction in visibility of the object can be suppressed by performing the above enlargement. The value of the angle of view of the virtual camera is discretionary and may not necessarily be set wide.

Next, an example of an object enlarging method will be described. In the exemplary embodiment, the game system 1 sets a magnification at which an object is enlarged, based on the distance from the virtual camera to the object. The magnification of the object is set such that the farther the distance from the virtual camera to the object within a predetermined range is, the higher the magnification is. In the exemplary embodiment, as the above distance, a three-dimensional distance from the virtual camera to the object in a three-dimensional virtual space is used. However, in other embodiments, as the above distance, a distance regarding the depth direction of the line of sight of the virtual camera, i.e., a distance regarding a depth component of the three-dimensional distance may be used.

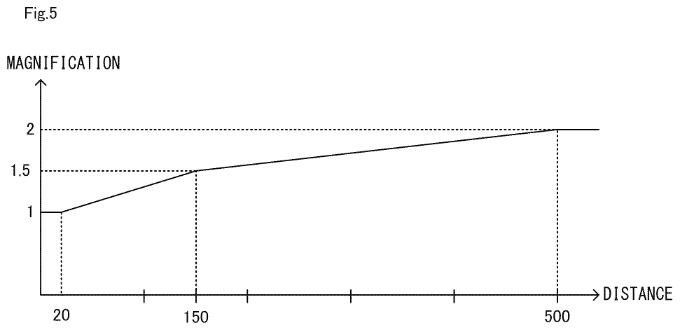

FIG. 5 is a graph showing an example of the relationship between magnification and distance when a moving object is enlarged. The horizontal axis of the graph shown in FIG. 5 represents the distance from the virtual camera to the moving object, and the vertical axis of the graph represents the magnification applied to the moving object.

As shown in FIG. 5, when the distance from the virtual camera to the moving object is within a range from 20 [m] to 500 [m], the magnification regarding the moving object is set such that the farther the distance is, the higher the magnification is. Specifically, the magnification regarding the moving object is set at 1× when the distance is 20 [m] or less (i.e., the moving object is not enlarged in this case), is set at 1.5× when the distance is 150 [m], and is set at 2× when the distance is 500 [m]. When the distance is within a range from 20 [m] to 150 [m], the magnification regarding the moving object is set to be a magnification obtained by linearly interpolating the magnification for 20 [m] (here, 1×) and the magnification for 150 [m](here, 1.5×). When the distance is within a range from 150 [m] to 500 [m], the magnification regarding the moving object is set to be a magnification obtained by linearly interpolating the magnification for 150 [m] (here, 1.5×) and the magnification for 500 [m] (here, 2×). Using the relationship between magnification and distance shown in FIG. 5, the game system 1 can calculate the magnification of the object through the simple calculation based on the distance from the virtual camera.

The interpolation method for determining the magnification between the first distance (20 [m] or 150 [m] in the example shown in FIG. 5) and the second distance (150 [m] or 500 [m] in the example shown in FIG. 5) is discretionary. For example, since linear interpolation is used as the above interpolation in the exemplary embodiment, the graph indicating the relationship between magnification and distance (see FIG. 5) is a straight line. However, in other embodiments, an interpolation method in which the graph is a curve may be used. The curve be an upward protruding curve or a downward protruding curve. In addition, as in the exemplary embodiment, when the above relationship is set such that the graph is composed of a continuous straight line or curve, it is possible to inhibit the size of the enlarged object from being abruptly changed when the distance has changed. However, in other embodiments, the graph may be composed of discontinuous straight lines or curves.

In the case where the graph becomes a straight line due to the linear interpolation, there is one point at which the inclination of the graph changes in the range where the magnification increases with an increase in distance (hereinafter referred to as “increase range”) in the exemplary embodiment (in the example shown in FIG. 5, the point at which the distance is 150 [m]). However, the number of such points may be two or more. By setting the point, the inclination of the graph can be changed in the middle of the increase range, whereby the relationship between distance and magnification in the increase range can be set in more detail. In other embodiments, the inclination of the graph in the increase range may be constant. The positions of the lower and upper limits of the increase range are discretionary, and are not limited to the positions shown in FIG. 5.

In the exemplary embodiment, in the increase range, the degree of increase in magnification in a first range regarding distance (range from 20 [m] to 150 [m] in the example shown in FIG. 5) is higher than the degree of increase in magnification in a second range (range from 150 [m] to 500 [m] in the example shown in FIG. 5) in which the distance is farther than in the first range (see FIG. 5). Thus, an object at a position far from the virtual camera is inhibited from being displayed too large. In other embodiments, the degree of increase in magnification in the first range may be equal to or lower than the degree of increase in magnification in the second range.

In the exemplary embodiment, the magnification in the case where the distance is farther than the increase range is 2× (see FIG. 5). Thus, in the exemplary embodiment, an upper limit is set for the magnification of the moving object. Thus, the object at the position far from the virtual camera is inhibited from being displayed too large. In other embodiments, the upper limit may not necessarily be set for the magnification. That is, the increase range may be infinite regarding the direction in which the distance increases.

In the exemplary embodiment, the game system 1 has, as a rendering target, an object whose distance from the virtual camera is equal to or less than a predetermined value. In the exemplary embodiment, the predetermined value is larger than the value of the distance (500 [m] in the example shown in FIG. 5) at which the magnification reaches the upper limit. In other embodiments, the predetermined value is discretionary, and for example, may be equal to the distance at which the magnification reaches the upper limit.

In the exemplary embodiment, a moving object whose distance from the virtual camera is closer than the increase range is not enlarged because it is less necessary for such a moving object to be enlarged. In addition, if an object at a position close to the virtual camera is enlarged and displayed, another object placed behind this object is hidden by this object, and visibility of the other object is reduced. Such a situation can be avoided in the exemplary embodiment. In the exemplary embodiment, the distance from the virtual camera to the player object in the case where the virtual camera is at the reference position is set to a distance (e.g., 4 [m]) shorter than the above 20 [m]. Therefore, in the exemplary embodiment, the player object is not enlarged in the above case. However, the virtual camera may not necessarily be always placed at a position close to the player object. For example, the virtual camera may be placed at a position far from the player object under certain conditions during the game. In this case, the player object may be enlarged. In other embodiments, enlargement of the player object may not be performed regardless of the distance from the virtual camera.

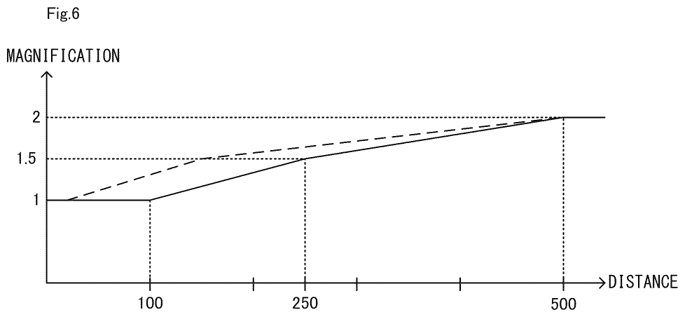

FIG. 6 is a graph showing an example of the relationship between magnification and distance in the case where another type of object different from a moving object is enlarged. The horizontal axis of the graph shown in FIG. 6 represents the distance from the virtual camera to the object, and the vertical axis of the graph represents the magnification applied to the object. In FIG. 6, the relationship between magnification and distance regarding the other type of object is represented by a solid line, and for a purpose of comparison, the relationship between magnification and distance regarding the moving object shown in FIG. 5 is represented by a broken line.

As shown in FIG. 6, when the distance from the virtual camera to the other type of object is within a range from 100 [m] to 500 [m], the magnification regarding this object is set such that the farther the distance is, the higher the magnification is. Specifically, the magnification regarding the object is set at 1× when the distance is 100 [m] or less, is set at 1.5× when the distance is 250 [m], and is set at 2× when the distance is 500 [m]. When the distance is within a range from 100 [m] to 250 [m], the magnification regarding the object is set to be a magnification obtained by linearly interpolating the magnification for 100 [m] (here, 1×) and the magnification for 250 [m] (here, 1.5×). When the distance is within a range from 250 [m] to 500 [m], the magnification regarding the object is set to be a magnification obtained by linearly interpolating the magnification for 250 [m] (here, 1.5×) and the magnification for 500 [m] (here, 2×). Like the graph regarding the moving object, the specific shape of the graph regarding the other type of object is also discretionary.

As described above, in the exemplary embodiment, the other type of object is enlarged at the magnification different from that for the moving object. In the exemplary embodiment, the relationship between the distance from the virtual camera and the magnification regarding the other type of object is different from that regarding the moving object. For example, in the exemplary embodiment, if the distance from the virtual camera to the moving object is equal to the distance from the virtual camera to the other type of object in the above increase range, the magnification of the moving object is set to be higher than that of the other type of object (see FIG. 6). Thus, visibility of the moving object that is highly likely to be watched by the player during the racing game can be improved more than that of the other type of object. The magnification setting method regarding the other type of object is discretionary. The magnification of the other type of object may be the same as that of the moving object in the case where the distances from virtual camera to these objects are the same, or may be set to be higher than that of the moving object. As will be described in detail below, in the exemplary embodiment, for a predetermined type of object among the other types of objects, a magnification is set based on a relationship different from the relationship shown in FIG. 6.

Furthermore, in the exemplary embodiment, an increase range regarding the other type of object is set to be different from the increase range regarding the moving object. In the exemplary embodiment, the increase range regarding the other type of object is set to be included in and narrower than the increase range regarding the moving object (see FIG. 6). In the exemplary embodiment, the lower limit (i.e., distance at which enlargement is started) of the increase range for the other type of object is 100 [m] while the lower limit of the increase range for the moving object is 20 [m]. In this case, the range of the enlargement display becomes wider for the moving object that is highly likely to be watched by the player during the racing game than for the other type of object, opportunities for improving the visibility can be increased. In other embodiments, an increase range for an object may be discretionarily set. The increase range for the other type of object may be the same as or wider than that for the moving object.

As for the other type of object, the magnification may not necessarily be set based on the relationship between magnification and distance shown in FIG. 6, and may be set based on a relationship that varies according to the type of the object. For example, as for an object that is originally big (e.g., object whose size before enlargement is a few times or more larger than the player object), visibility of such an object is less likely to be reduced even if the distance from the virtual camera is far. Therefore, the game system 1 may set the magnification of such an object to be lower than the magnification based on the relationship shown in FIG. 6, or may not enlarge such an object.

In the exemplary embodiment, the moving object can acquire an item object during the game, and in this case, the moving object is in the state of holding the item object. In this state, if the moving object and the item object have different magnifications, the appearance may become unnatural. Therefore, the game system 1 may set the magnification of the item object to the same magnification as that of the moving object.

In the exemplary embodiment, the box object is placed on the racing course. For example, the moving object can acquire an item object by touching the box object during the game. In the exemplary embodiment, the box object is placed on the racing course where the moving object is moving. Therefore, if the moving object and the box object, which are both located on the racing course, have a difference in size due to enlargement, the player may feel discomfort. Therefore, in order to avoid such a difference in size, the magnification of the box object may be set to the same magnification as that of the moving object.

The game system 1 may set a magnification equal to or higher than the magnification of the moving object, for an object to which the player should pay attention among the other types of objects. This object is, for example, an object that affects the progress of the race of the player object, such as the obstacle object described above. For example, the upper limit of the magnification for this object may be set to a value (e.g., 2.5×) higher than the upper limit of the magnification regarding the moving object. In addition, for example, the increase range regarding this object may be set to be wider than the increase range regarding the moving object.

In the exemplary embodiment, enlargement is performed for predetermined types of objects including the moving object, in other words, not all the objects in the virtual space are subjected to enlargement. For example, in the exemplary embodiment, a terrain object and a building object are not subjected to enlargement regardless of the distance from the virtual camera. In other embodiments, the game system 1 may subject the objects placed on the racing course to enlargement.

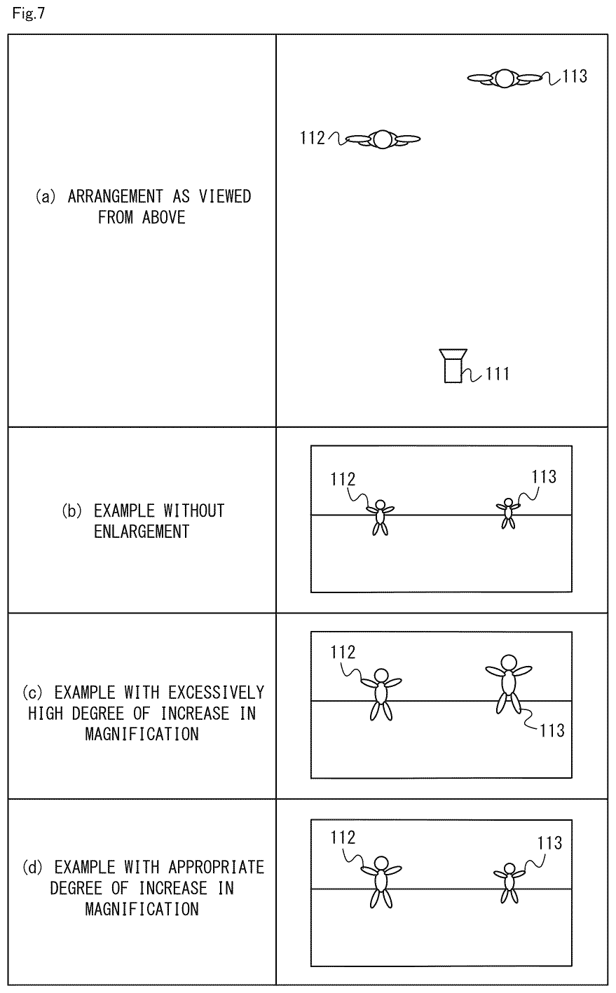

In the exemplary embodiment, the magnification regarding an object is set such that the size of the object after enlargement is larger than the size of the object after enlargement in the case where this object is farther from the virtual camera. FIG. 7 shows examples of a case where two objects placed on the field are not enlarged and cases where the two objects are respectively enlarged at different magnifications. In FIG. 7, (a) shows the positional relationship between a virtual camera 111 and each of objects 112 and 113 when the field is viewed from above. As shown in (a) of FIG. 7, in this example, the distance from the virtual camera 111 to the object 112 is shorter than the distance from the virtual camera 111 to the object 113, and the objects 112 and 113 in the virtual space have the same size.

In FIG. 7, (b) shows an example of a game image in the case where the objects 112 and 113 are not enlarged. As shown in (b) of FIG. 7, when enlargement is not performed, the object 112 at a closer distance from the virtual camera 111 is displayed to be larger than the object 113 at a farther distance from the virtual camera 111.

In FIG. 7, (c) shows an example of a game image in the case where the objects 112 and 113 are enlarged. In FIG. 7, (c) shows an example of the case where the degree of increase in magnification within the increase range is too high (i.e., inclination of the graph is too steep). Here, if the magnification in the case where the distance from the virtual camera is far is excessively higher than the magnification in the case where the distance from the virtual camera is close, a reversal phenomenon occurs as shown in (c) of FIG. 7 in which the display size of the object 113 at a position far from the virtual camera becomes larger than the display size of the object 112 at a position close to the virtual camera. In this case, for the player, the object 113 appears to be closer to the player than the object 112, which may make the player feel discomfort. Moreover, in the example shown in (c) of FIG. 7, although one object gradually goes away from the virtual camera in the virtual space, this object is displayed with a gradually increasing size on the display. Therefore, for the player, it looks as if this object gradually approaches the virtual camera, which may make the player feel discomfort.

For the purpose of reducing the above possibility, in the exemplary embodiment, the magnification in the increase range is set such that the size of an object after enlargement at a first distance is larger than the size of the object after enlargement at a second distance farther than the first distance. In FIG. 7, (d) shows an example of a game image in the case where each of the objects 112 and 113 is enlarged at an appropriate degree of increase. In the example shown in (d) of FIG. 7, the objects 112 and 113 are enlarged and displayed, and the object 112 is displayed to be larger than the object 113. Thus, visibilities of the objects 112 and 113 can be improved without making the player feel discomfort as described above.

As described above, in the exemplary embodiment, an upper limit is set for the magnification. Specifically, the upper limit of the magnification is set at 2× (2.5× for a predetermined type of object) in the case where the distance from the virtual camera is 500 [m] or more. Also in this case, the possibility of a reversal phenomenon as shown in the example of (c) of FIG. 7 can be reduced, thereby reducing the possibility that the player feels discomfort.

Next, a method for enlarging and displaying an object will be described. In the exemplary embodiment, the game system 1 enlarges an object in a rendering process for generating a game image showing a game space. In the exemplary embodiment, the game system 1 has a function of a vertex shader, and in the process of rendering an object, enlarges and renders the object with the vertex shader, at a magnification set for the object according to the above method.

FIG. 8 shows an example of the method for enlarging and rendering an object. FIG. 8 shows an example of enlarging an object 124, and the object 124 before enlargement is indicated by dotted lines. In the exemplary embodiment, the vertex shader converts the coordinates of the vertices of the object 124 so as to enlarge the object 124, and perspectively projects the converted coordinates onto a screen coordinate system to perform a rendering process. Thus, an enlarged image of the object 124 is obtained.

In the exemplary embodiment, the object is enlarged in the rendering process as described above. The enlargement is performed only in the rendering process and therefore does not affect other processing such as collision determination. The size of the object in the virtual space is not changed due to the enlargement, and a determination area used in the collision determination for the object is also not changed due to the enlargement. Consequently, according to the exemplary embodiment, since the process of enlarging an object does not affect the collision determination for the object in the virtual space, the collision determination can be accurately performed.

In the exemplary embodiment, a moving object can perform an action of throwing an acquired predetermined item object toward another moving object. If the item object hits the other moving object, the other moving object spins and temporarily stops, thereby impeding the movement of the other moving object. In the exemplary embodiment, as described above, even if the moving object is enlarged and displayed, this enlargement of the moving object does not affect collision determination. Therefore, for example, the inconvenience that the enlarged moving object becomes more likely to be hit by the item object, can be avoided.

In the case where an object is enlarged and displayed as described above, the enlarged object may interfere with another object placed around the enlarged object, which may result in unnatural display. For example, the object may be displayed as if it is buried in the ground (i.e., terrain object). Therefore, in the exemplary embodiment, the game system 1 enlarges the object to reduce the possibility of such an unnatural display. Specifically, in the exemplary embodiment, the game system 1 sets an enlargement base point on the lower surface of the object, and performs the coordinate conversion for enlarging the object on the basis of the enlargement base point (e.g., such that the position of the enlargement base point does not change before and after the enlargement). The lower surface of the object is, for example, a surface that includes the lower end of the object and is parallel to the horizontal direction in the virtual space (see FIG. 8). The lower surface of the object may not necessarily be a surface of the object. For example, when the object is placed on the ground, the lower surface may be a surface including a part in contact with the ground. The coordinate conversion being performed based on the enlargement base point set on the lower surface of the object, can reduce the possibility that the object placed on the ground is unnaturally displayed as if it is buried in the ground, for example. In other embodiments, the specific enlargement process is discretionary. For example, the enlargement base point may be set at any position.

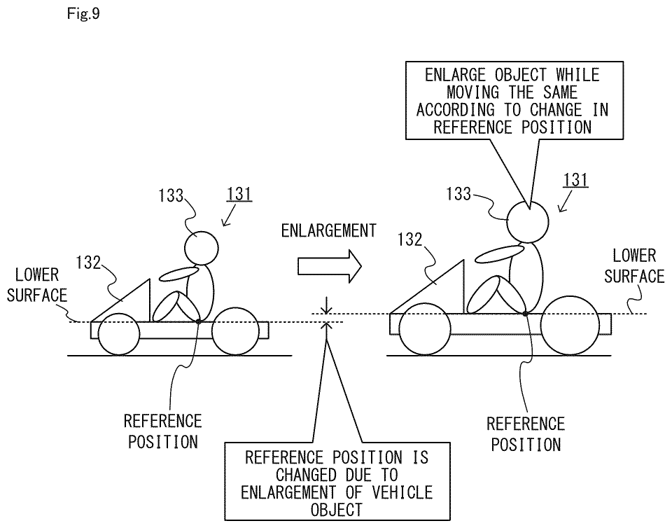

FIG. 9 shows an example of enlargement of a moving object. As shown in FIG. 9, a moving object 131 of the exemplary embodiment is composed of a vehicle object 132 and a character object 133 riding in the vehicle object 132. In the exemplary embodiment, enlargement of the moving object 131 is performed by individually enlarging the vehicle object 132 and the character object 133. In the exemplary embodiment, since a magnification is set for the moving object 131, the vehicle object 132 and the character object 133 included in the moving object 131 are enlarged at the same magnification. In other embodiments, the game system 1 may perform an enlargement process such that the moving object 131 composed of the vehicle object 132 and the character object 133 is enlarged as a single object.

The game system 1 enlarges the vehicle object 132, based on an enlargement base point set on the lower surface of the vehicle object 132 in the same manner as that shown in FIG. 8. In this case, since the height of the lower surface of the vehicle object 132 is at the position unchanged from that before the enlargement, it is possible to reduce the possibility that the vehicle object 132 is unnaturally displayed as if it is buried in the ground, for example.

The character object 133 is placed such that it rides in the vehicle object 132 as shown in FIG. 9. Specifically, the character object 133 is placed such that the lower surface of the character object 133 is located at a reference position in the vehicle object 132 (see FIG. 9). The reference position is set at the position of a seat of the vehicle object 132. Here, the reference position is different from the enlargement base point of the vehicle object 132. However, the reference position and the enlargement base point may be set at the same position.

When the vehicle object 132 has been enlarged, the reference position in the vehicle object 132 changes (specifically, moves upward). Therefore, if the character object 133 is placed such that the lower surface is located at the reference position before enlargement, there is a possibility that the character object 133 is unnaturally displayed as if it is buried in the vehicle object 132. Therefore, in the exemplary embodiment, the game system 1 enlarges and renders the character object 133 such that the lower surface of the enlarged character object 133 is located at the reference position of the vehicle object after enlargement (see FIG. 9). Specifically, the game system 1 sets an offset corresponding to a change in the reference position due to enlargement of the vehicle object 132. In the rendering process, the game system 1 enlarges and renders the character object 133 while moving the character object 133 upward according to the offset. The amount of change in the reference position due to enlargement of the vehicle object 132 (i.e., the amount of the offset) can be calculated based on the magnification of the moving object 131 and the length from the enlargement base point of the vehicle object 132 to the reference position. Thus, the enlarged moving object 131 in which the character object 133 rides in the vehicle object 132 can be naturally displayed.

### [3. Specific Example of Processing in Game System]

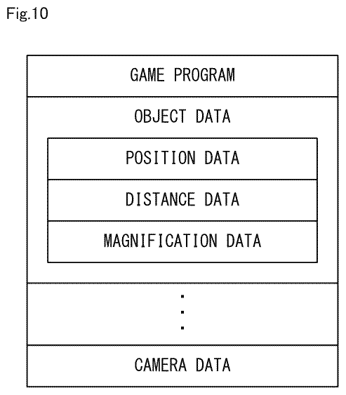

Next, a specific example of information processing in the game system 1 will be described with reference to FIG. 10 to FIG. 13. FIG. 10 shows an example of a storage area having, stored therein, various kinds of data to be used for information processing in the game system 1. The data shown in FIG. 10 are stored in, for example, a storage medium (e.g., the flash memory 26, the DRAM 27, and/or a memory card attached to the slot 29) that is accessible by the main body apparatus 2, for example.

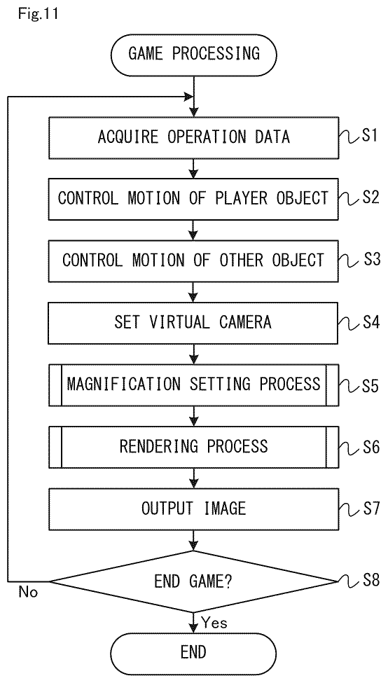

As shown in FIG. 10, the game system 1 stores a game program therein. The game program is a program for executing game processing (processes shown in FIG. 11 to FIG. 13) to be executed in the main body apparatus 2. The processor 21 of the main body apparatus 2 executes the game program, whereby processes described later are executed in the game system 1.

As shown in FIG. 10, the game system 1 stores therein object data and camera data. When the game is started, the respective data are set to indicate initial states.

The object data indicates information regarding objects. The objects include a moving object as a player object, moving objects other than the player object, an obstacle object, an audience object, an item object, and a box object. The game system 1 stores therein the object data for each object. In the exemplary embodiment, the object data includes position data, distance data, and magnification data. The position data indicates the position of the object on the field. The distance data indicates the distance from the virtual camera to the object. The magnification data indicates the magnification of the object. The object data may include other data according to the type of the object, in addition to the position data and the magnification data. For example, object data regarding a moving object may include data indicating the direction and the speed of the moving object, data indicating the state of the moving object, and the like. In addition, object data regarding an object of a type not to be enlarged may not necessarily include the distance data and the magnification data.

The camera data indicates information regarding the virtual camera. For example, the camera data includes data indicating the position, the direction, the angle of view, etc., of the virtual camera.

FIG. 11 is a flowchart showing an example of a flow of game processing executed by the game system 1. Execution of the game processing is started in response to, for example, an instruction to start the game, which is made by the player during execution of the game program.

In the exemplary embodiment, the processor 21 of the main body apparatus 2 executes the game program stored in the game system 1 to execute the processes in steps shown in FIG. 11 to FIG. 13. If the game system 1 is communicable with another information processing apparatus (e.g., a server), a part of the processes in the steps shown in FIG. 11 to FIG. 13 may be executed by the other information processing apparatus. The processes in the steps shown in FIG. 11 to FIG. 13 are merely examples, and the processing order of the steps may be changed or another process may be executed in addition to (or instead of) the processes in the steps as long as similar results can be obtained.

The processor 21 executes the processes in the steps shown in FIG. 11 to FIG. 13 by using a memory (e.g., the DRAM 27 or a memory included in the SoC). The processor 21 stores information (in other words, data) obtained in each process step, into the memory, and reads out the information from the memory when using the information for the subsequent process steps.

In step S1 shown in FIG. 11, the processor 21 acquires the operation data indicating an operation input performed by the player. Specifically, the processor 21 acquires the operation data received from the respective controllers via the controller communication section 25 and/or the terminals 22 and 23. Next to step S1, the process in step S2 is executed.

In step S2, the processor 21 controls the motion of the player object, based on the operation data acquired in step S1. For example, the processor 21 determines the speed and the advancement direction of the player object, based on the operation data, thereby determining the position and the direction of the player object in the current frame. In addition, the processor 21 performs collision determination regarding the player object. When it is determined that the player object comes into contact with another object (e.g., another moving object or an item object), the processor 21 determines the position and the direction of the player object taking into account the contact. The processor 21 updates the object data stored in the memory so that the object data indicates the new position and direction of the player object. Next to step S2, the process in step S3 is executed.

In step S3, the processor 21 controls the motions of objects other than the player object which are placed in the virtual space. The motions of the other objects are controlled based on rules defined in advance in the game program, for example. If the racing game is performed as a multi-player game, the motion of the moving object other than the player object may be controlled based on an operation input performed by a player other than the player of the game system 1. In this case, operation data indicating the operation input performed by the other player is transmitted from another information processing apparatus corresponding to the other player, and is received by the network communication section 24 to be acquired, for example. Furthermore, the processor 21 performs collision determination on a moving object, and when it is determined that the moving object comes into contact with another object (e.g., another moving object or an item object), the processor 21 determines the position and the direction of the moving object taking into account the contact. In a single process in step S3, the motion that the object performs over a period equivalent to one frame is determined, and the position, the direction, etc., of the object in the current frame are calculated. The processor 21 updates the object data stored in the memory so that the object data indicates the new position and direction of the object. Next to step S3, the process in step S4 is executed.

The motions of the moving objects participating in the racing game are controlled through the processes in steps S2 and S3, whereby the racing game is progressed.

In step S4, the processor 21 performs setting of the virtual camera. As described above, if an operation input regarding the virtual camera is not performed, the position and the direction of the virtual camera are calculated such that the virtual camera follows the player object from the back side. When an operation input regarding the virtual camera is performed, the virtual camera is set such that the position and the direction thereof are changed according to the operation input. The processor 21 updates the camera data stored in the memory so that the camera data indicates the contents set as described above. Next to step S4, the process in step S5 is executed.

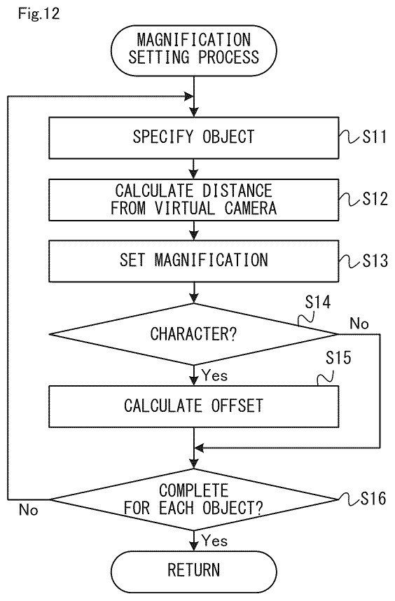

In step S5, the processor 21 executes a magnification setting process. In the magnification setting process, magnification and the like are set for an object to be enlarged during the rendering process. Hereinafter, the magnification setting process in step S5 will be described in detail with reference to FIG. 12.

FIG. 12 is a sub-flowchart showing an example of a specific flow of the magnification setting process in step S5 shown in FIG. 11. In the magnification setting process, firstly, in step S11, the processor 21 specifies one object for which magnification is to be set. The object for which a magnification is to be set is an object that is a rendering target and is of a type to be subjected to an enlargement process. The object to be a rendering target is, for example, an object whose distance from the virtual camera is within a predetermined distance. In the exemplary embodiment, the aforementioned moving object and obstacle object are objects to be subjected to the enlargement process while the terrain object and the building object are objects not to be subjected to the enlargement process. In step S11, an object that has not yet been processed in the current processing loop of steps S11 to S16 is specified. Next to step S11, the process in step S12 is executed.

In step S12, the processor 21 calculates the distance from the virtual camera to the object specified in step S11. This distance is calculated based on the position indicated by the object data stored in the memory and the position indicated by the camera data stored in the memory. The processor 21 updates the distance data in the object data stored in the memory so that the distance data indicates the calculated distance value. Next to step S12, the process in step S13 is executed.

In step S13, the processor 21 sets the magnification regarding the object designated in step S11. The magnification is set according to the method described in the above [2. Game example in game system] (see FIG. 5 to FIG. 7), based on the distance calculated in step S12. The processor 21 updates the magnification data in the object data stored in the memory so that the magnification data indicates the set magnification value. Next to step S13, the process in step S14 is executed.

In step S14, the processor 21 determines whether or not the object specified in step S11 is a character object included in a moving object. When the determination result in step S14 is positive, the process in step S15 is executed. When the determination result in step S14 is negative, the process in step S16 is executed.

In step S15, the processor 21 sets an offset for enlargement of the object specified in step S11 (specifically, character object). This offset is calculated based on the magnification set in step S13 and the height from the enlargement base point of the vehicle object corresponding to the character object to the reference position of the vehicle object. Next to step S15, the process in step S16 is executed.

In step S16, the processor 21 determines whether or not setting of magnifications has been completed for the target objects. That is, the processor 21 determines whether or not all the objects for which magnifications are to be set have been specified in step S11. When the determination result in step S16 is positive, the processor 21 ends the magnification setting process. When the determination result in step S16 is negative, the process in step S11 is executed again.

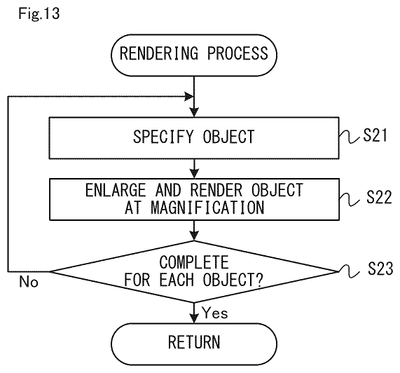

Referring back to FIG. 11, in step S6 next to step S5, the processor 21 executes the rendering process. In the rendering process, a game image showing a game space as viewed from the position of the virtual camera set in step S4 is generated. Hereinafter, the rendering process in step S6 will be described in detail with reference to FIG. 13.

FIG. 13 is a sub-flowchart showing an example of a specific flow of the rendering process in step S6 shown in FIG. 11. In the rendering process, firstly, in step S21, the processor 21 specifies one object to be a rendering target. The object to be a rendering target is, for example, an object whose distance from the virtual camera is within a predetermined distance. In step S21, an object that has not yet been processed in the current processing loop of steps S21 to S23 is specified. Next to step S21, the process in step S22 is executed.

In step S22, the processor 21 enlarges and renders the object specified in step S21, at the magnification set in the magnification setting process in step S5. Specifically, the processor 21 writes the enlarged image of the object into a frame buffer according to the method described in the above [2. Game example in game system] (see FIG. 8 and FIG. 9). If an offset is set through the process in step S15, enlargement with upward movement according to the offset is performed. If the magnification is set at 1× in step S13, this object is substantially rendered without being enlarged. An object for which a magnification is not set, i.e., an object of a type not to be subjected to the enlargement process, is rendered without being enlarged. Next to step S22, the process in step S23 is executed.

In step S23, the processor 21 determines whether or not the rendering process has been completed for the objects as the rendering targets. That is, the processor 21 determines whether or not all the objects to be rendering targets have been specified in step S21. When the determination result in step S23 is positive, the processor 21 ends the rendering process. When the determination result in step S23 is negative, the process in step S21 is executed again.

In the rendering process shown in FIG. 13, rendering of objects has been described. However, in the rendering process, rendering of background and rendering of an UI image, etc., to be displayed on the game space image may be performed in addition to rendering of objects.

Referring back to FIG. 11, in step S7 next to step S6, the processor 21 outputs the game image generated through the rendering process in step S6 to a display device. Specifically, the game image rendered in the frame buffer is outputted to the display device, whereby the game image is displayed on the display device. The display device to which the game image is outputted may be the display 12 of the main body apparatus 2, or may be a monitor that is different from the display 12 and is connected to the main body apparatus 2. In the exemplary embodiment, a processing loop composed of steps S1 to S8, including step S7, is repeatedly executed in a cycle of once every predetermined time. Thus, the displayed game image is updated once every one-frame time.

In step S8, the processor 21 determines whether or not to end the game processing. For example, the processor 81 determines to end the game when a predetermined operation input for ending the game has been performed by the player, or when a condition for ending the game has been completed (e.g., the moving objects participating in the racing game have crossed the finish line). When the determination result in step S8 is negative, the process in step S1 is executed again. Thereafter, a series of processes in steps S1 to S8 is repeated until the processor 21 determines to end the game in step S8. When the determination result in step S8 is positive, the processor 81 ends the game processing shown in FIG. 11.

### [4. Functions and Effects of Exemplary Embodiment, and Modifications]

As described above, in the exemplary embodiment, an object far from the virtual camera is enlarged and rendered to improve visibility of the object. In addition, in the exemplary embodiment, within the predetermined range regarding distance, the magnification of an object is set such that the farther the distance is, the higher the magnification is. Thus, visibility of the object that is farther from the virtual camera can be more improved. In addition, in the exemplary embodiment, since enlargement of an object is performed with the vertex shader, the object on the display can be enlarged without affecting the processes such as collision determination.

In the exemplary embodiment, the racing game in which the player object races with another moving object is executed. However, the content of the game to be executed is not limited to the racing game. In a game of a type other than the racing game, visibility of an object can be improved by enlarging the object by the method according to the exemplary embodiment.

In other embodiments, the game system 1 may enlarge an object by the method according to the exemplary embodiment even when the player object to be controlled by the player does not appear. For example, the game system 1 may have a function of progressing a race in which the player object of the player of the game system 1 does not participate. The above race is, for example, a race in which only moving objects to be automatically controlled participate, or a race in which a player object of another player different from the player of the game system 1 participates. Even in the case where the state of such a race is displayed, the game system 1 may enlarge an object by the method according to the exemplary embodiment. In this case as well, visibility of the object can be improved as in the exemplary embodiment.

In the exemplary embodiment, when processing is executed by using data (including a program) in a certain information processing apparatus, a part of the data required for the processing may be transmitted from another information processing apparatus different from the certain information processing apparatus. In this case, the certain information processing apparatus may execute the processing by using the data received from the other information processing apparatus and the data stored therein.

In other embodiments, the information processing system may not necessarily include some of the components included in the exemplary embodiment, and may not necessarily execute some of the processes executed in the exemplary embodiment. For example, in order to achieve a certain specific effect of the exemplary embodiment, the information processing system may include a component for achieving the effect and execute a process for achieving the effect, in other words, the information processing system may not necessarily include the other components and execute the other processes.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable medium having stored therein instructions that, when executed, cause one or more processors of an information processing apparatus to execute information processing comprising:
performing a racing game by causing a player object controlled based on an operation input and a plurality of other moving objects to move on a field in a virtual space; and
in the racing game,
setting a virtual camera in the virtual space at a position behind the player object, in a direction in which at least the player object is included in a field of view of the virtual camera, so that the virtual camera follows movement of the player object, and
based on the virtual camera, performing rendering of the objects in the virtual space, and during the rendering, enlarging and rendering at least the other moving object among the objects in the virtual space by using a vertex shader, at a magnification that increases as at least a distance from the virtual camera becomes farther within a first range.

2. The non-transitory computer-readable medium according to claim 1, wherein
the magnification is set to be a first magnification when the distance from the virtual camera is a first distance, to be a second magnification higher than the first magnification when the distance from the virtual camera is a second distance farther than the first distance, and to be a magnification obtained by linearly interpolating the first magnification and the second magnification according to the distances between the first distance and the second distance.

3. The non-transitory computer-readable medium according to claim 2, wherein
the magnification is set to be a third magnification higher than the second magnification when the distance from the virtual camera is a third distance farther than the second distance, and to be a magnification obtained by linearly interpolating the second magnification and the third magnification according to the distances between the second distance and the third distance.

4. The non-transitory computer-readable medium according to claim 1, wherein
the information processing further comprises, during the rendering, enlarging and rendering an object of a type other than the player object and the other moving objects among the objects in the virtual space by using the vertex shader, at a magnification that increases as at least the distance from the virtual camera becomes farther within a second range and that is different from the magnifications of the other moving objects.

5. The non-transitory computer-readable medium according to claim 1, wherein
the information processing comprises, during the rendering, enlarging at least the other moving object at the magnification by using the vertex shader, and rendering the other moving object at a position where a height of a lower surface of the other moving object is not changed from that before the enlargement.

6. The non-transitory computer-readable medium according to claim 5, wherein
the other moving object is an object including a vehicle object and a character object riding in or on the vehicle object at a reference position on the vehicle object, and
the information processing comprises, during the rendering, enlarging at least the other moving object at the magnification by using the vertex shader, and rendering the other moving object such that the vehicle object is rendered at a position where a height of a lower surface of the vehicle object is not changed from that before the enlargement and the character object is rendered at a position where a height of a lower surface of the character object is on the reference position of the vehicle object after the enlargement.

7. The non-transitory computer-readable medium according to claim 1, wherein
the distance from the virtual camera is a distance in the virtual space or a distance regarding a depth component of the virtual camera.

8. An information processing system comprising:
one or more processors that are configured to execute information processing comprising:
performing a racing game by causing a player object controlled based on an operation input and a plurality of other moving objects to move on a field in a virtual space; and
in the racing game,
setting a virtual camera in the virtual space at a position behind the player object, in a direction in which at least the player object is included in a field of view of the virtual camera, so that the virtual camera follows movement of the player object, and
based on the virtual camera, performing rendering of the objects in the virtual space, and during the rendering, enlarging and rendering at least the other moving object among the objects in the virtual space by using a vertex shader, at a magnification that increases as at least a distance from the virtual camera becomes farther within a first range.

9. The information processing system according to claim 8, wherein
the magnification is set to be a first magnification when the distance from the virtual camera is a first distance, to be a second magnification higher than the first magnification when the distance from the virtual camera is a second distance farther than the first distance, and to be a magnification obtained by linearly interpolating the first magnification and the second magnification according to the distances between the first distance and the second distance.

10. The information processing system according to claim 9, wherein
the magnification is set to be a third magnification higher than the second magnification when the distance from the virtual camera is a third distance farther than the second distance, and to be a magnification obtained by linearly interpolating the second magnification and the third magnification according to the distances between the second distance and the third distance.

11. The information processing system according to claim 8, wherein
the information processing further comprises, during the rendering, enlarging and rendering an object of a type other than the player object and the other moving objects among the objects in the virtual space by using the vertex shader, at a magnification that increases as at least the distance from the virtual camera becomes farther within a second range and that is different from the magnifications of the other moving objects.

12. The information processing system according to claim 8, wherein
the information processing comprises, during the rendering, enlarging at least the other moving object at the magnification by using the vertex shader, and rendering the other moving object at a position where a height of a lower surface of the other moving object is not changed from that before the enlargement.

13. The information processing system according to claim 12, wherein
the other moving object is an object including a vehicle object and a character object riding in or on the vehicle object at a reference position on the vehicle object, and
the information processing comprises, during the rendering, enlarging at least the other moving object at the magnification by using the vertex shader, and rendering the other moving object such that the vehicle object is rendered at a position where a height of a lower surface of the vehicle object is not changed from that before the enlargement and the character object is rendered at a position where a height of a lower surface of the character object is on the reference position of the vehicle object after the enlargement.

14. The information processing system according to claim 8, wherein
the distance from the virtual camera is a distance in the virtual space or a distance regarding a depth component of the virtual camera.

15. A game processing method performed on an information processing system, the game processing method comprising:
performing a racing game by causing a player object controlled based on an operation input and a plurality of other moving objects to move on a field in a virtual space; and
in the racing game,
setting a virtual camera in the virtual space at a position behind the player object, in a direction in which at least the player object is included in a field of view of the virtual camera, so that the virtual camera follows movement of the player object, and
based on the virtual camera, performing rendering of the objects in the virtual space, and during the rendering, enlarging and rendering at least the other moving object among the objects in the virtual space by using a vertex shader, at a magnification that increases as at least a distance from the virtual camera becomes farther within a first range.

16. The game processing method according to claim 15, wherein
the magnification is set to be a first magnification when the distance from the virtual camera is a first distance, to be a second magnification higher than the first magnification when the distance from the virtual camera is a second distance farther than the first distance, and to be a magnification obtained by linearly interpolating the first magnification and the second magnification according to the distances between the first distance and the second distance.

17. The game processing method according to claim 16, wherein
the magnification is set to be a third magnification higher than the second magnification when the distance from the virtual camera is a third distance farther than the second distance, and to be a magnification obtained by linearly interpolating the second magnification and the third magnification according to the distances between the second distance and the third distance.

18. The game processing method according to claim 15, further comprises
during the rendering, enlarging and rendering an object of a type other than the player object and the other moving objects among the objects in the virtual space by using the vertex shader, at a magnification that increases as at least the distance from the virtual camera becomes farther within a second range and that is different from the magnifications of the other moving objects.

19. The game processing method according to claim 15, comprises,
during the rendering, enlarging at least the other moving object at the magnification by using the vertex shader, and rendering the other moving object at a position where a height of a lower surface of the other moving object is not changed from that before the enlargement.

20. The game processing method according to claim 19, wherein
the other moving object is an object including a vehicle object and a character object riding in or on the vehicle object at a reference position on the vehicle object, and
the game processing method comprises, during the rendering, enlarging at least the other moving object at the magnification by using the vertex shader, and rendering the other moving object such that the vehicle object is rendered at a position where a height of a lower surface of the vehicle object is not changed from that before the enlargement and the character object is rendered at a position where a height of a lower surface of the character object is on the reference position of the vehicle object after the enlargement.

21. The game processing method according to claim 15, wherein
the distance from the virtual camera is a distance in the virtual space or a distance regarding a depth component of the virtual camera.
